(19) United States
(12) Patent Application Publication
(10) Pub. No.: US 2018/0367722 A1
(43) Pub. Date: Dec. 20, 2018

(54) IMAGE ACQUISITION DEVICE AND IMAGE ACQUISITION METHOD

(71) Applicant: CANON KABUSHIKI KAISHA, Tokyo (JP)

(72) Inventors: Hidenori Hashiguchi, Utsunomiya-shi (JP); Hideki Matsuda, Kawachi-gun (JP)

(21) Appl. No.: 16/005,353

(22) Filed: Jun. 11, 2018

(30) Foreign Application Priority Data
Jun. 14, 2017 (JP) 2017-116780

(51) Int. Cl. H04N 5/235; G06T 7/00; G06T 7/40

(52) U.S. Cl. CPC H04N 5/2354; H04N 5/2353; G06T 2207/30164; G06T 7/40; G06T 7/0004

(57) ABSTRACT

An image acquisition device includes a member having a plurality of non-transmissive portions that extends in a first direction and does not transmit at least a part of incident light. The plurality of non-transmissive portions being disposed in a second direction intersecting the first direction at intervals of a period P. The image acquisition device further includes a first illumination unit, an imaging unit that images an area of an illuminated target via the member, and a driving unit that relatively shifts the member and the target in the second direction during exposure for acquiring one image by imaging the target illuminated by the first illumination unit.

### BACKGROUND OF THE INVENTION

### Field of the Invention

One aspect of the disclosed embodiments relates to an image acquisition device, such as an optical evaluation device for inspecting a target, and an image acquisition method for acquiring an image of a target to process the image.

### Description of the Related Art

As a technology for detecting a defect on a surface of a workpiece which is a target having glossiness, Japanese Patent No. 5994419 and Japanese Patent No. 4147682 discuses publicly-known technologies that illuminate a workpiece using a light source that emits light through a periodically striped pattern and images light reflected by the workpiece using a camera. In an inspection method discussed in Japanese Patent No. 5994419, a workpiece is illuminated with light having periodically changing luminance, an amplitude and an average value of a luminance change of a captured reflected light image are calculated, and a defect of the workpiece is detected based on the calculated values. In an inspection method discussed in Japanese Patent No. 4147682, a minute defect is inspected by capturing a plurality of images while a contrast pattern to be emitted to a workpiece is being shifted, by calculating evaluation amounts such as maximum values and minimum values of respective pixels, and by comparing the evaluation amounts between the pixels.

Inspection methods discussed in Japanese Patent No. 5994419 and Japanese Patent No. 4147682 have limitation indirections of illumination and image capturing with respect to defects, depending on certain types of defects. Therefore, visualization of the defects is sometimes insufficient only by pattern illumination. In this case, if another illumination (for example, bar illumination) is used, defects can be visualized. It is, however, sometimes difficult to arrange a pattern illumination and a bar illumination in such a manner that the pattern illumination and the bar illumination share one imaging system.

If a transmission-type pattern illumination that allows imaging over a pattern illumination unit is used, a degree of freedom in a layout of an imaging system and various types of illumination units is heightened. Accordingly, downsizing of the device, reduction in an inspection time, and the like can also be possible. However, imaging over a pattern illumination unit may cause the pattern to appear on a captured image, and this pattern becomes a noise component. As a result, defect detection accuracy may be deteriorated.

### SUMMARY OF THE INVENTION

According to an aspect of the embodiments, an image acquisition device includes a member having a plurality of non-transmissive portions that extends in a first direction and does not transmit at least a part of incident light, the plurality of non-transmissive portions being disposed in a second direction intersecting the first direction at intervals of a period P, a first illumination unit, an imaging unit configured to image an area of a target illuminated by the first illumination unit via the member, and a driving unit configured to shift relative positions of the member and the target in the second direction during exposure in which the imaging unit images the target illuminated by the first illumination unit and acquires an image.

Further features of the disclosure will become apparent from the following description of exemplary embodiments with reference to the attached drawings.

### BRIEF DESCRIPTION OF THE DRAWINGS

FIG. 1 is a diagram illustrating an optical evaluation device that is an image acquisition device according to a first exemplary embodiment.

FIG. 2 is a diagram illustrating a second illumination unit according to the first exemplary embodiment.

FIG. 3 is a diagram illustrating a cross section of the second illumination unit according to the first exemplary embodiment.

FIG. 4 is a flowchart illustrating a defect inspection method according to the first exemplary embodiment.

FIG. 5 is a diagram illustrating a contrast noise to be generated on an image in a case where a first illumination unit is used.

FIG. 6 is a diagram illustrating the second illumination unit and a movable mechanism according to a second exemplary embodiment.

### DESCRIPTION OF THE EMBODIMENTS

An image acquisition device and an image acquisition method from one aspect of the embodiments use a member and a first illumination unit that illuminates a target. The member is configured such that a plurality of non-transmissive portions that extends in a first direction and does not transmit at least a part of incident light is disposed in a second direction intersecting with the first direction at intervals of a period P. An area of the target illuminated by the first illumination unit is imaged via the member. The member and the target are relatively shifted in the second direction during exposure in which the illuminated target is imaged and one image is acquired. The member can configure the second illumination unit that illuminates a target in a mode different from a mode of the first illumination unit. The length of each of the plurality of non-transmissive portions in the first direction is longer than the length thereof in the second direction (desirably twice longer than the length in the second direction). Further, it is desirable that the first direction and the second direction are perpendicular to each other.

Exemplary embodiments of the disclosure will be described below with reference to the accompanying drawings. In the drawings, members or elements that are similar to each other are denoted by the same reference numerals, and overlapped description about them will be omitted or simplified.

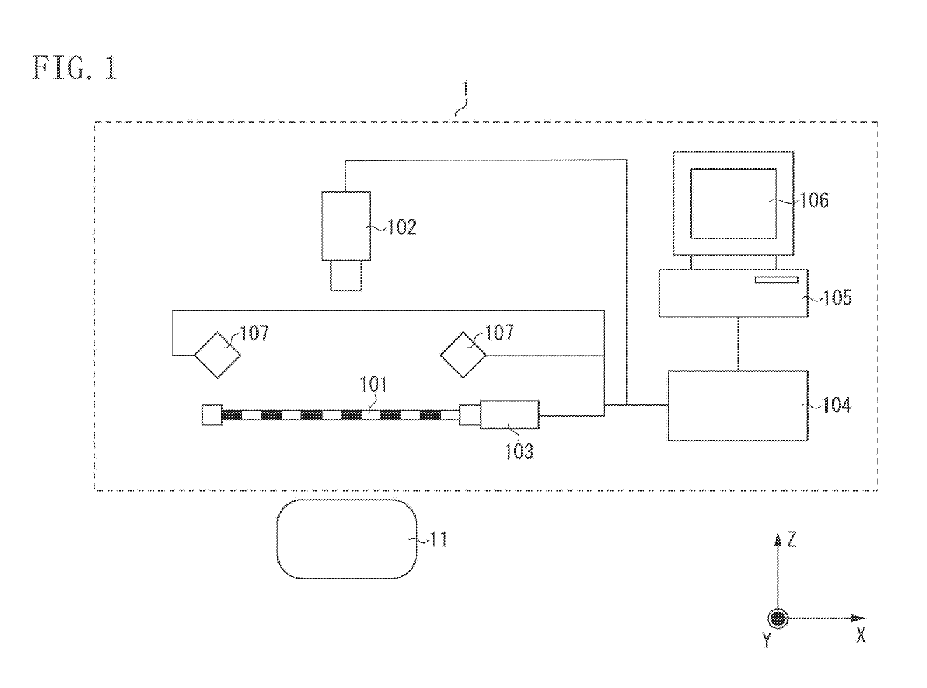

An optical evaluation device 1 that is a device for processing an image of a target (workpiece) according to a first exemplary embodiment will be described. FIG. 1 is a schematic diagram illustrating the optical evaluation device 1. The optical evaluation device 1 optically evaluates a surface of a workpiece 11 (target) having glossiness. The target or workpiece 11 is, for example, a metallic component or a resin component having a polished surface to be used for industrial products. A variety of defects can occur on the surface of the workpiece 11. Examples of such defects include a scratch, a color void, and a defect caused by slight unevenness such as a dent. The optical evaluation device 1 evaluates processed image information acquired by processing an acquired image of the surface of the workpiece 11 to detect such defects, and classifies, based on detected results, the workpiece 11 into a non-defective object or a defective object, for example. The optical evaluation device 1 includes a conveyance device, not illustrated, that conveys the workpiece 11 to a predetermined position (for example, a conveyor, a robot, a slider, a manual stage, etc.).

The optical evaluation device 1 includes a first illumination unit 107 that illuminates a workpiece, a second illumination unit 101, a camera 102 as an imaging unit that images the workpiece 11 from above via the second illumination unit 101. The camera 102 adopts an image sensor, such as a charge-coupled device (CCD) image sensor or a complementary metal-oxide semiconductor (CMOS) image sensor, in which pixels are disposed two-dimensionally. Use of such an area sensor camera makes it possible to acquire at once an image of an area wider than an imaging area acquirable by a line sensor camera. For this reason, a wide surface range of a workpiece can be evaluated quickly. In the first exemplary embodiment, an object-side telecentric optical system can be used in the camera.

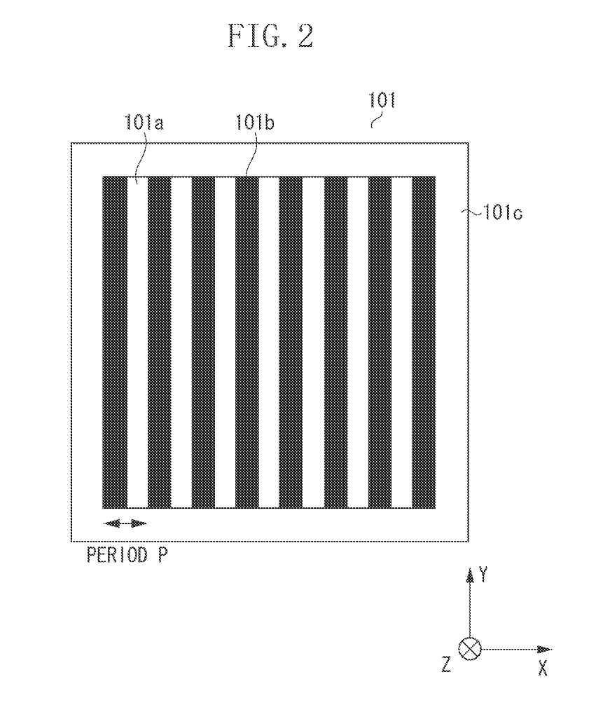

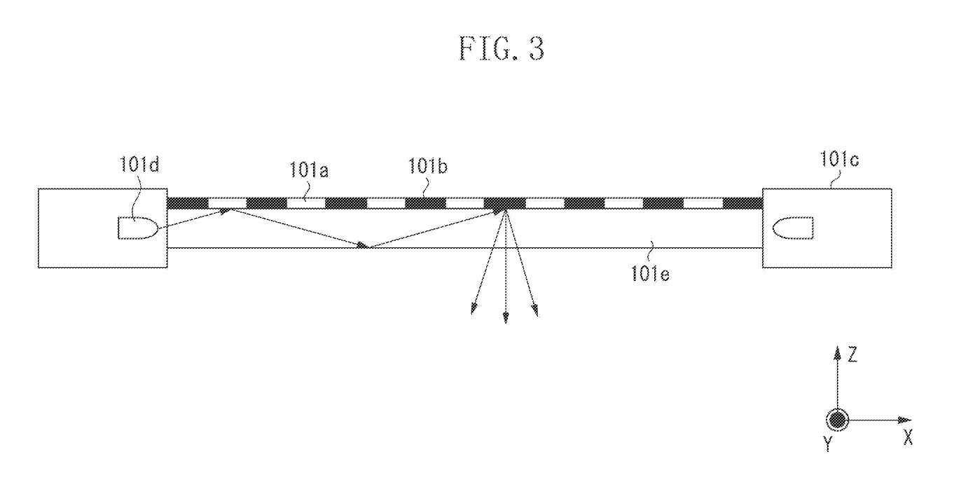

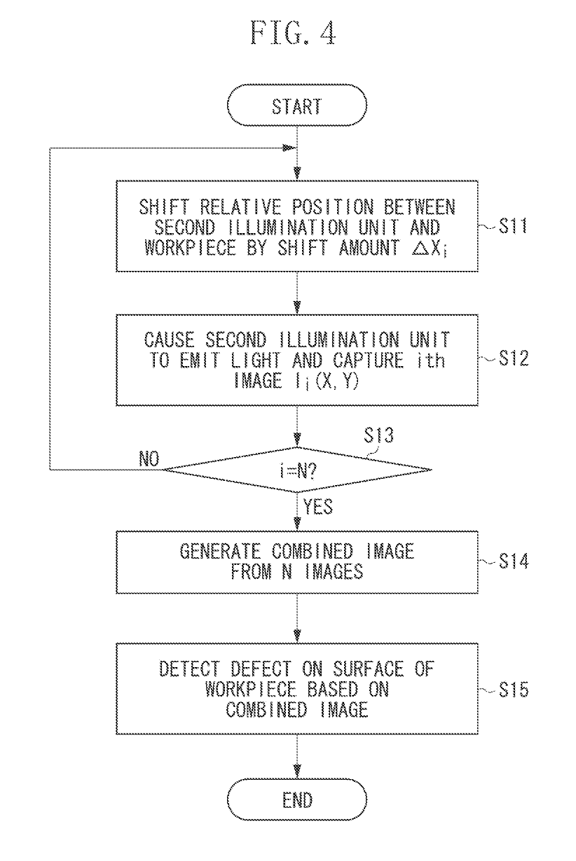

A process until a combined image is created from the captured images by using the second illumination unit 101 will be described with reference to FIG. 2, FIG. 3, and FIG. 4.

FIG. 2 is a diagram illustrating the second illumination unit 101 having a linear pattern. The second illumination unit 101 includes a member in which a plurality of transmissive portions 101a formed in a linear shape and a plurality of non-transmissive portions 101b formed in a linear shape are disposed alternately in a predetermined direction with a constant period P. The transmissive portions 101a transmits at least a part of light. The non-transmissive portions 101b have transmissivity at least lower than the transmissivity of the transmissive portions 101a. The transmissive portions 101a can be an opening or a space. The member including such transmissive portions can be defined as such a member that has the following configuration: the plurality of non-transmissive portions 101b which extends in the first direction and does not transmit at least a part of incident light is disposed in the second direction intersecting the first direction at intervals of the period P. The member including the transmissive portions 101a and the non-transmissive portions 101b is supported by a frame portion 101c.

FIG. 3 is a cross-sectional view illustrating the second illumination unit 101 in one form. The second illumination unit 101 further includes a light-emitting diode (LED) 101d as a light source, and a light guide plate 101e. The light guide plate 101e is, for example, an acrylic or glass flat board. The non-transmissive portions 101b can be obtained by printing a striped pattern on a film with the period P using, for example, a material having light scattering property. In such a case, film portions on which the striped pattern is not printed by using the light scattering material become the transmissive portions 101a. The film on which the pattern has been printed is brought close contact with the light guide plate 101e. The LED 101d is disposed on appropriate one or more positions that are inside the frame portion 101c and within an area surrounding the transmissive portions 101a and the non-transmissive portions 101b. Light emitted from the LED 101d travels inside the light guide plate 101e while being totally reflected. Since the light scattering material is used for the non-transmissive portions 101b, a part of incident light is scattered toward the workpiece 11. On the other hand, since light is hardly scattered on the transmissive portions 101a, there is hardly any light reflected from the transmissive portions 101a towards the workpiece 11. Accordingly, striped pattern light is projected onto the workpiece 11 by the second illumination unit 101. A part of light reflected or scattered by the workpiece 11 is shielded by the non-transmissive portions 101b of the second illumination unit 101, and a part of the light passes through the transmissive portions 101a of the second illumination unit 101. The transmitted light is imaged by the camera 102, and thus the camera 102 can image the workpiece 11 via the second illumination unit 101.

In the present exemplary embodiment, the transmissive portions 101a and the non-transmissive portions 101b are obtained by the striped pattern printed on the film using the light scattering material, but the illumination units are not limited to such a configuration. For example, as described above, the transmissive portions 101a can be configured by linear openings and the non-transmissive portions 101b can be configured by linear light emitting members.

As illustrated in FIG. 1, the second illumination unit 101 is supported by a movable mechanism 103 that is a driving unit. The movable mechanism 103 is configured such that the second illumination unit 101 is movable in a direction (X direction in the drawing) orthogonal to the lines of the transmissive portions 101a and the non-transmissive portions 101b. In the present exemplary embodiment, the second illumination unit 101 is moved by the movable mechanism 103. Alternatively, the workpiece 11 can be moved with respect to the second illumination unit 101 to shift the relative position between the second illumination unit 101 and the workpiece 11. Furthermore, only the transmissive portions 101a and the non-transmissive portions 101b (namely, the member) can be moved without entirely moving the second illumination unit 101.

The movable mechanism 103 is connected to a control unit 104. The control unit 104 includes, for example, a substrate having a central processing unit (CPU) and a memory, and synchronizes the second illumination unit 101, the camera 102, and the movable mechanism 103 to perform control. The control unit 104 controls the movable mechanism 103 and the camera 102, to cause the movable mechanism 103 to move the second illumination unit 101 by ΔXᵢ(i=1, 2, . . . N) , and causes the camera 102 to capture a plurality of N images. That is, when the member and the target are relatively shifted in the second direction by shift amounts ΔXᵢ(i=1, 2, . . . N) during illumination by the second illumination unit, the camera 102 images the target to capture N images via the member. The shift amounts ΔXᵢ(i=1, 2, . . . N) are values different from each other, and all the shift amounts ΔXᵢ(i=1, 2, . . . N) are different from an amount of an integral multiple of the period P. The reason of excluding an amount of an integral multiple of the period P is to exclude a case in which relative positions of the member (i.e., the second illumination unit 101 or the transmissive portions 101a and the non-transmissive portions 101b included in the second illumination unit 101) with respect to the camera 102 and the workpiece 11 become equal. In other words, while relative positional relationships between three objects of the camera 102, the member (i.e., the second illumination unit 101 or the transmissive portions 101a and the non-transmissive portions 101b included in the second illumination unit 101), and the workpiece 11 are finely changed, N images are captured. In such a case, image capturing is not needed to perform more than twice for the case where the relative positional relationships between the three objects (as for the member, the non-transmissive portions 101b or the transmissive portions 101a) become equal. Any value can be set to the value ΔXᵢ as long as the value is known. However, the configuration is not limited to this. For example, the workpiece 11 is manually moved by operating the movable mechanism 103, and the workpiece 11 can be imaged by the camera 102 using a manual trigger.

The optical evaluation device 1 can further include a personal computer (PC) 105 as an image processing unit, and a display 106. The PC 105 according to the present exemplary embodiment has a function for evaluating the surface of the workpiece 11 based on information about the N images captured by the camera 102. The PC 105 and the control unit 104 does not have to be separated bodies, or the image processing unit 105 and the control unit 104can be integrally provided. Further, the image processing unit 105 is not necessarily a general-purpose PC, but can be a machine exclusive to image processing, or specially designed for the task. The image captured by the camera 102 is transmitted to the PC 105 via a cable, not illustrated.

FIG. 4 illustrates an example of a processing procedure of the inspection method for a defect on a workpiece surface using the optical evaluation device 1 according to the present exemplary embodiment. In step S11, the second illumination unit 101 is moved by the movable mechanism 103, and the relative position between the second illumination unit 101 and the workpiece 11 is shifted by ΔX₁ with respect to a reference position. In step S12, the second illumination unit 101 is caused to emit light at this position, and a first image I₁(x, y) is captured. Symbols x and y represent positions of pixels on the image. The value ΔX₁ can be 0 and the first image can be positioned at the reference position. Next, returning to step S11, The second illumination unit 101 is moved by the movable mechanism 103, and the relative position between the second illumination unit 101 and the workpiece 11 is shifted by ΔX₂ with respect to the reference position. In step S12, the second illumination unit 101 is caused to emit light at this position, and a second image I₂(x, y) is captured (step S12). These steps are repeated at N times so that totally N (N≥3) images are captured.

In a case where the relative position between the second illumination unit 101 and the workpiece 11 is shifted by ΔXᵢ, the processing proceed to S14. In step S14, a combined image or a processed image is generated from the N images by using information about an intensity change in a frequency component in which a phase shifts by 4πΔXᵢ/P radian. The frequency component corresponds to a striped pattern of a period P/2, for example, to be generated on an image.

An example of the combined image is an amplitude image of the frequency component in which the phase shifts by 4πΔXᵢ/P radian. In a case where the relative position between the second illumination unit 101 and the workpiece 11 is shifted at a step of P/N (equal interval) width, the shift amount ΔXᵢ(i=1, 2, . . . N) is expressed by the following formula.

ΔXᵢ=P/N×(i−1)

This formula includes the case where ΔX₁ is 0. In a case where the first image is obtained after a shift from the reference position, the shift amount is expressed by the following formula.

ΔXᵢ=(P/N)×i

The amplitude image A(x, y) can be calculated by the following formula. This is the processed image including information about the target surface obtained by processing the N (N≥3) images. Further, the combined image is a processed image generated by using information about an intensity change of a frequency component in which the phase shifts by 4πΔXᵢ/P radian (for example, the frequency component corresponding to the striped pattern of a period P/2).

$$A ( x , y ) = \sqrt{{I}_{si n}^{2} ( x , y ) + {I}_{co s}^{2} ( x , y )} \\ {I}_{si n} ( x , y ) = {\sum }_{n = 0}^{N - 1} {I}_{n + 1} ( x , y ) sin ( 4 π n / N ) \\ {I}_{co s} ( x , y ) = {\sum }_{n = 0}^{N - 1} {I}_{n + 1} ( x , y ) cos ( 4 π n / N ) \qquad ( 1 )$$

If the position of the second illumination unit 101 is shifted, intensity contrast changes at one point on the pixels of the camera 102. As to the workpiece 11 having glossiness, an amplitude corresponding to a difference in the contrast is generated on a surface portion having normal glossiness. On the other hand, scattered light other than specular reflection light is generated on a portion with a light scattering defect, such as a scratch, minute unevenness, or a rough surface. Presence of the scattered light reduces the difference in the contrast and also the amplitude value. For example, since a light scattering angle distribution does not depend on an angle of incident light on a perfectly diffusing surface, even if the striped pattern is projected onto the workpiece 11 by the second illumination unit 101, the light scattering angle distribution is always uniform. As a result, the amplitude becomes 0. For this reason, a degree of a light scattering property can be evaluated as a surface texture on the amplitude image, and thus information about light scattering defects, such as a scratch, minute unevenness, and a rough surface can be acquired. Further, the defects can be visualized.

Another example of the combined image is a phase image of the frequency component in which the phase shifts by 4πΔXᵢ/P radian. The phase image θ(x, y) can be calculated by the following formula.

$$θ ( x , y ) = {tan}^{- 1} ( \frac{{I}_{si n} ( x , y )}{{I}_{co s} ( x , y )} ) \qquad ( 2 )$$

With the above formula, the calculated phase is ranging from −π to π. Thus, if the phase shifts further, discontinuous phase, namely, phase jump occurs on the phase image. Therefore, phase unwrapping is performed as needed.

A surface tilt of the workpiece 11 can be evaluated as a surface texture on the phase image. Therefore, information about defects caused by a slight shape change, such as a dent, surface tilting, and a surface recess, can be acquired using the phase image. The defects can be visualized.

Various types of algorithms are proposed for the phase unwrapping. However, if an image noise is large, an error sometimes occur. As means for avoiding the phase unwrapping, a phase difference corresponding to a phase differential can be calculated. The phase differences Δθₓ(x, y) and Δθ_{y}(x, y) can be calculated by the following formula.

$$Δ {θ}_{x} ( x , y ) = {tan}^{- 1} ( \frac{{I}_{co s} ( x , y ) {I}_{co s} ( x - 1 , y ) + {I}_{si n} ( x , y ) {I}_{s i n} ( x - 1 , y )}{{I}_{s i n} ( x , y ) {I}_{co s} ( x - 1 , y ) - {I}_{c o s} ( x , y ) {I}_{s i n} ( x - 1 , y )} ) \\ Δ {θ}_{y} ( x , y ) = {tan}^{- 1} ( \frac{{I}_{co s} ( x , y ) {I}_{co s} ( x , y - 1 ) + {I}_{si n} ( x , y ) {I}_{s i n} ( x , y - 1 )}{{I}_{s i n} ( x , y ) {I}_{co s} ( x , y - 1 ) - {I}_{c o s} ( x , y ) {I}_{s i n} ( x , y - 1 )} ) \qquad ( 3 )$$

Yet another example of the combined image is an average image. An average image Iₐᵥₑ(x, y) can be calculated by the following formula.

$${I}_{ave} ( x , y ) = \frac{1}{N} {\sum }_{n = 1}^{N} {I}_{n} ( x , y ) \qquad ( 4 )$$

In the average image, a reflectance distribution can be evaluated as a surface texture. Therefore, on the average image, information about defects, such as a color void, a soil, and an absorbent foreign substance, of a portion which is different in reflectance from a normal portion can be acquired. The defects can be visualized.

In such a manner, between the amplitude image, the phase image or the phase difference image, and the average image, a surface texture that can be optically evaluated varies. Thus, a defect to be visualized varies. For this reason, these images are combined so that various types of surface textures are evaluated and various types of defects can be visualized.

In step S15, a defect on the surface of the workpiece 11 is detected by using the combined image generated in step S14.

However, azimuths of the illumination and the imaging that allow visualization of defects are sometimes limited in accordance with types of defects due to an influence of a reflection characteristic or the like. Thus, a defect cannot be detected on the combined image in some cases. In this case, illumination suitable for each defect is disposed, and visualization of defects becomes necessarily.

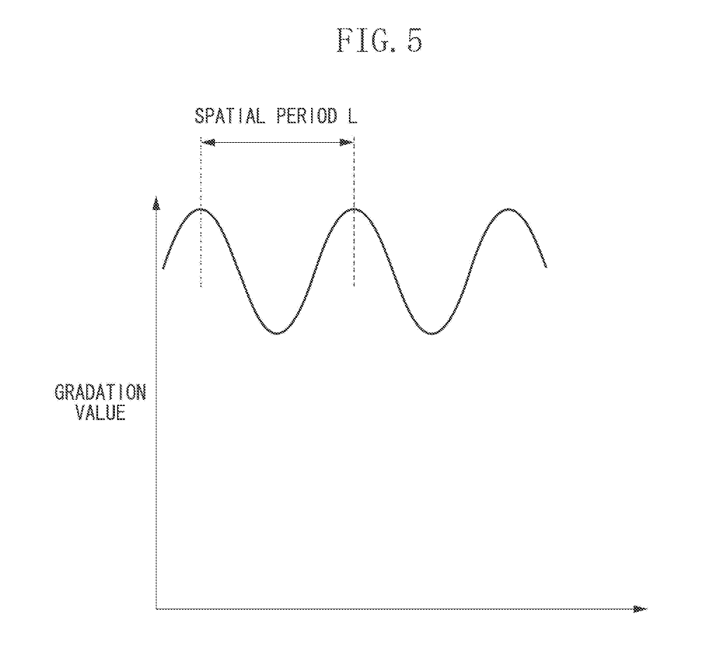

In the present exemplary embodiment, a detailed description will be given of a case where the first illumination unit 107 that realizes a dark field is used as the illumination suitable for a defect, with reference to FIG. 1, FIG. 2, FIG. 3, and FIG. 5. A part of light emitted from the first illumination unit 107 is shielded by the non-transmissive portions 101b of the second illumination unit 101. A part of the light is transmitted through the transmissive portions 101a of the second illumination unit 101 and reaches the workpiece 11. A part of the light reflected from or scattered by the workpiece 11 is again shielded by the non-transmissive portions 101b of the second illumination unit 101. A part of the light is transmitted through the transmissive portions 101a of the second illumination unit 101. The transmitted light is imaged by the camera 102. As a result, during the illumination by the first illumination unit 107, the camera 102 can image the workpiece 11 via the member including the transmissive portions 101a and the non-transmissive portions 101b of the second illumination unit 101.

Herein, the first illumination unit 107 is disposed in such a manner that light normally reflected by the workpiece 11 does not reach the camera 102. As a result, only scattered light can reach the camera 102. With this layout, a defected portion can be imaged brightly with respect to a periphery of the detected portion by using the first illumination unit 107. Further, the first illumination unit 107 is disposed in such a manner that the largest amount of the scattered light can reach the camera 102. As a result, an image in which contrast is the highest between a normal portion and a defected portion can be captured. As an example of such a layout, in the configuration in FIG. 1, optical axes of the two light sources as the first illumination unit 107 are tilted with respect to an optical axis of the camera 102. In FIG. 1, the first illumination unit 107 is disposed between the second illumination unit 101 and the camera 102, but can be disposed in a space on a side of the workpiece 11 of the member including the transmissive portions 101a and the non-transmissive portions 101b of the second illumination unit 101.

However, the following case occurs during the illumination by the first illumination unit 107. That is, if the camera 102 images the workpiece 11 via the second illumination unit 101, an image of the transmissive portions 101a and the non-transmissive portions 101b of the second illumination unit 101 is formed as a linear contrast noise on the image captured by the camera 102. A cross-sectional image of the linear contrast noise is illustrated in FIG. 5. In FIG. 5, a horizontal axis represents an X coordinate of the camera 102 equivalent to an X coordinate on the workpiece 11 in FIG. 1, and a vertical axis represents a cross-sectional image acquired by plotting a gradation value of the image acquired by the camera 102. As illustrated in FIG. 5, the contrast noise appears as a periodic (spatial period L) change in the gradation value. The spatial period L of the linear contrast noise is sometimes equal to the period of the intensity change in the frequency component in which the phase shifts by 4πΔXᵢ/P radiant when imaging is performed by the second illumination unit 101. However, normally these periods are different. Therefore, the imaging using the second illumination unit 101 and the imaging using the first illumination unit 107 are needed to be performed separately. The spatial period L of the contrast noise is determined by a numerical aperture (NA) of an optical system of the camera 102, a duty of the transmissive portions of the member including the transmissive portions and the non-transmissive portions, a focus position of the optical system of the camera 102, and a spatial configuration relationship between the first illumination unit 107 and the member. The spatial period L can be obtained in advance by measurement or can be theoretically calculated from a design value of the device.

As a countermeasure against the linear contrast noise, in the imaging by the camera 102, the movable mechanism 103 moves, at a constant speed, the member including the transmissive portions and the non-transmissive portions of the second illumination unit 101 in a direction (X direction in the drawing) orthogonal to lines of the transmissive portions 101a and the non-transmissive portions 101b. The movable mechanism 103 is connected to the control unit 104. The control unit 104 synchronizes the light emission from the first illumination unit 107, the imaging by the camera 102, and the operation of the movable mechanism 103 with each other to perform control. Further, the control unit 104 sets a relationship among a constant speed V[m/s] of the member including the transmissive portions 101a and the non-transmissive portions 101b of the second illumination unit 101, the spatial period L[m] of the contrast noise, and an exposure time T[s] of the camera 102 so that the following formula holds:

V*T=mL (5)

where m is an integer.

That is, during illumination by the first illumination unit 107, a distance of a change in the relative position within an exposure time required by the imaging by the camera 102 is an integral multiple of a period of a contrast pattern to be appeared on an image due to the presence of the member including the transmissive portions 101a and the non-transmissive portions 101b.

In a case where the first illumination unit 107 illuminates (irradiates) a target with striped light via the member, a relative shift amount can be determined as follows. That is, the driving unit can set the relative shift amount between the member and the target along the second direction during the exposure for acquiring one image to an amount of an integral multiple of a half of the period P. The relative shift amount is preferably the amount of integral multiple of the half of the period P, but can be deviated from the integral multiple if the deviation is 5% or less (more preferably, 3% or less). Further, the relative shift amount of the member and the target by the driving unit along the second direction during the exposure for acquisition of one image can be 5 or more times of the half of the period P. Preferably, the amount is 10 or more times of the half of the period P.

According to such a measuring method, the contrast noise which is caused by the presence of the member including the transmissive portions 101a and the non-transmissive portions 101b of the second illumination unit 101 can be averaged by m period. As a result of this averaging effect, the contrast noise can be reduced. In the configuration according to the present exemplary embodiment, the movable mechanism 103 moves, at a constant speed, the member including the transmissive portions 101a and the non-transmissive portions 101b of the second illumination unit 101. However, a similar effect can be obtained by the following configuration: the member is not moved, and the positions of the camera 102 and the workpiece 11 are simultaneously moved at a constant speed.

Further, in the configuration according to the present exemplary embodiment, the member including the transmissive portions 101a and the non-transmissive portions 101b is moved at a constant speed within the exposure time of the camera 102. However, the spatial period L of the contrast noise can be divided into a plurality of periods to make step movements. An image is acquired at each step movement to capture a plurality of images, and averaging processing is performed to the plurality of images. As a result, the similar effect can be produced. Further, in the present exemplary embodiment, the member is moved by the movable mechanism 103. However, the workpiece 11 can be moved with respect to the member so that the relative position between the member and the workpiece 11 is shifted. In this case, the plurality of captured images is averaged after the image processing in which the positions of the workpiece 11 on the plurality of images match with one another. Further, the entire second illumination unit 101 is not moved, but only the member including the transmissive portions 101a and the non-transmissive portions 101b can be moved for the imaging.

As described above, in order to visualize a defect, in a case where another illumination, in addition to the pattern illumination, is used, the imaging in which the contrast noise is reduced can be performed. The present exemplary embodiment can provide the optical evaluation device in which a noise is low in the device in which transmissive pattern illumination is used, a degree of layout freedom of an imaging system and the illumination units is high, and a size and an inspection time can be reduced.

The optical evaluation device 1 according to the present exemplary embodiment generates a combined image including information about the surface of the workpiece 11, and detects a defect from the combined image to perform, for example, a defectiveness determination on the workpiece 11. However, an application of a device such as the optical evaluation device 1 according to the present exemplary embodiment is not limited to defect detection on the surface of the workpiece 11. For example, a device to which the disclosure can be applied may be used for measuring a shape of a workpiece surface using information about a phase image including information about a surface tilt of the workpiece 11. Further, a device to which the disclosure can be applied may be used for measuring glossiness using information about an amplitude image including information about a scattering property of the workpiece surface.

The optical evaluation device according to a second exemplary embodiment will be described below. The optical evaluation device according to the second exemplary embodiment is similar to the optical evaluation device according to the first exemplary embodiment except for differences in the second illumination unit and the movable mechanism.

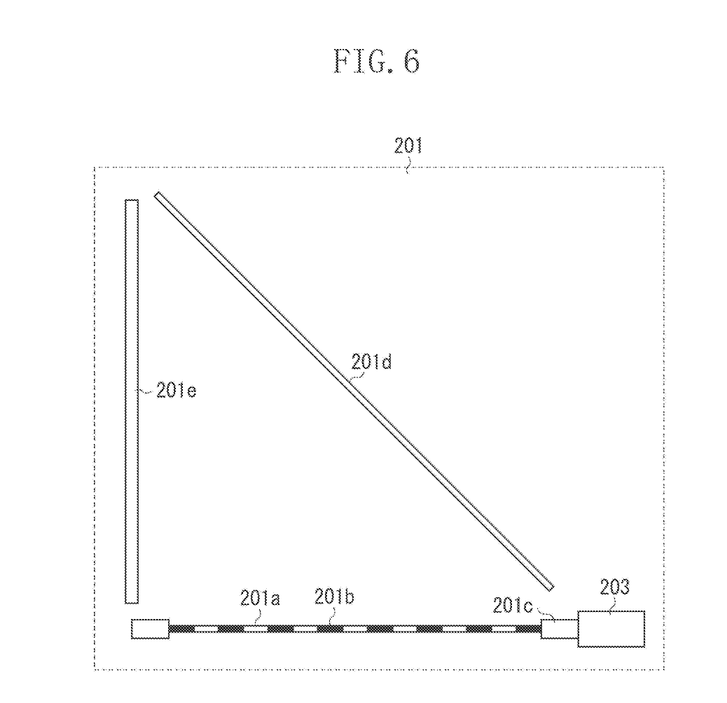

FIG. 6 is a diagram for describing a second illumination unit 201 and a movable mechanism 203 of the optical evaluation device according to the second exemplary embodiment. The second illumination unit 201 includes a member having transmissive portions 201a formed in a linear shape and non-transmissive portions 201b formed in a linear shape. The transmissive portions 201a and the non-transmissive portions 201b are alternately disposed with the period P. As described above, this member can be defined as such a member that has the following configuration: the plurality of non-transmissive portions 201b which extends in the first direction and does not transmit at least a part of incident light is disposed in the second direction intersecting the first direction at intervals of the period P. The transmissive portions 201a and the non-transmissive portions 201b can be implemented by providing linear openings using, for example, a transparent display that is electrically controllable. The transmissive portions 201a and the non-transmissive portions 201b are supported by a frame portion 201c. The member having the transmissive portions 201a and the non-transmissive portions 201b can be shifted by a movable mechanism 203 to a direction (second direction) orthogonal to a line extended to the first direction. The movable mechanism 203 is a driver, etc. of the transparent display, and controls the position of the member based on an instruction from the control unit 104 (not illustrated).

The second illumination unit 201 further includes a half mirror 201d and a planar light source 201e. A part of light emitted from the planar light source 201e is reflected by the half mirror 201d, and is transmitted through the transmissive portions 201a to illuminate the workpiece 11 into a stripe shape. A part of the light reflected and scattered by the workpiece 11 is again transmitted through the transmissive portions 201a to be received and imaged by the camera 102.

The second illumination unit 201 according to the second exemplary embodiment needs the half mirror 201d, and is slightly larger than the second illumination unit 101 according to the first exemplary embodiment. Further, in the second illumination unit 101 according to the first exemplary embodiment, the non-transmissive portions 101b function as a secondary light source that scatters light to a variety of directions. Meanwhile, in the second illumination unit 201 according to the second exemplary embodiment, the light that is transmitted through the transmissive portions 201a and is emitted to the workpiece has directivity. In order to acquire specular reflection light of the light having directivity from a wide range of the surface of the workpiece 11, it is desirable to use an object-side telecentric optical system for the camera. Not illustrated in FIG. 6, but also in the second exemplary embodiment, the first illumination unit 107 is provided. Similarly to the first exemplary embodiment, the first illumination unit 107 can be disposed between the second illumination unit 201 and the camera 102, but may be disposed in a space on a target side of the second illumination unit 201.

Further, in a case where the second illumination unit 201 includes a self-luminous transparent display, a configuration can be such that the half mirror 201d and the planar light source 201e are not necessary. In this case, an installation area becomes small, and thus further downsizing of the device can be realized.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-116780, filed Jun. 14, 2017, which is hereby incorporated by reference herein in its entirety.

What is claimed is:

1. An image acquisition device comprising:
a member having a plurality of non-transmissive portions that extends in a first direction and does not transmit at least a part of incident light, the plurality of non-transmissive portions being disposed in a second direction intersecting the first direction at intervals of a period P;
a first illumination unit;
an imaging unit configured to image an area of a target illuminated by the first illumination unit via the member; and
a driving unit configured to shift relative positions of the member and the target in the second direction during exposure in which the imaging unit images the target illuminated by the first illumination unit and acquires an image.

2. The image acquisition device according to claim 1,
wherein the first illumination unit illuminates the target with striped light via the member, and
wherein an amount of relative shift of the member and the target by the driving unit in the second direction during the exposure for acquiring one image is an integral multiple of a half of the period P.

3. The image acquisition device according to claim 1,
wherein the first illumination unit illuminates the target with striped light via the member, and
wherein an amount of relative shift of the member and the target by the driving unit in the second direction during the exposure for acquiring the one image is 5 or more times of a half of the period P.

4. The image acquisition device according to claim 1, wherein a distance, by which the relative positions shift within an exposure time needed for the imaging unit to capture the image during illumination by the first illumination unit, is an integral multiple of a cycle of a contrast pattern to be generated on the image due to presence of the member.

5. The image acquisition device according to claim 1, wherein the first illumination unit is disposed between the member and the imaging unit.

6. The image acquisition device according to claim 1, wherein the first illumination unit is disposed in a space on a side of the target of the member.

7. The image acquisition device according to claim 1, further comprising an image processing unit configured to generate a processed image including information about a surface of the target by processing an image of the target captured by the imaging unit during illumination by the first illumination unit.

8. The image acquisition device according to claim 1,
wherein the member configures a second illumination unit configured to project striped light to the target,
wherein the image acquisition device further includes
an image processing unit configured to generate a processed image including information about a surface of the target by processing a plurality of N images captured by the imaging unit during illumination by the second illumination unit, and
wherein during the illumination by the second illumination unit, when the member and the target are relatively shifted by the driving unit in the second direction by shift amounts ΔXᵢ(i=1, 2, . . . N), the imaging unit acquires the N images by imaging the target via the member, the shift amounts ΔXᵢ(i=1, 2, . . . N) being different from each other, and all the shift amounts ΔXᵢ(i=1, 2, . . . N) being different from an amount of an integral multiple of the period P.

9. The image acquisition device according to claim 8, wherein the image processing unit generates the processed image from the N images using information about an intensity change in a frequency component of a striped pattern generated on the N images, the N images being captured by the imaging unit during the illumination by the second illumination unit, a phase being shifted between the N images.

10. The image acquisition device according to claim 9, wherein the image processing unit acquires at least one of an amplitude, a phase, and a phase difference of the frequency component of the intensity change from the information about the intensity change to generate at least one of an amplitude image, a phase image, and a phase difference image as the processed image.

11. The image acquisition device according to claim 8, wherein the second illumination unit includes the member, and a light source disposed within an area surrounding the member.

12. The image acquisition device according to claim 8,
wherein the second illumination unit includes the member, a half mirror, and a light source, and
wherein a part of light emitted from the light source is reflected by the half mirror and illuminates the target after passing between the non-transmissive portions, and a part of light from the target passes between the non-transmissive portions and is received and imaged by the imaging unit.

13. The image acquisition device according to claim 7, wherein the image processing unit optically evaluates the surface of the target having glossiness, based on the processed image acquired during the illumination by the first illumination unit.

14. The image acquisition device according to claim 13, wherein the image processing unit detects a defect on the surface of the target, based on the processed image.

15. The image acquisition device according to claim 8, wherein the image processing unit optically evaluates the surface of the target having glossiness, based on both or one of the processed image acquired during the illumination by the first illumination unit and the processed image acquired during the illumination by the second illumination unit.

16. An image acquisition method comprising:
illuminating a target;
imaging an area of the target illuminated in the illuminating via a member having a plurality of non-transmissive portions that extends in a first direction and does not transmit at least a part of incident light, the plurality of non-transmissive portions being disposed in a second direction intersecting the first direction at intervals of a period P; and
relatively shifting relative positions of the member and the target in the second direction during exposure for acquiring one image by imaging the area of the target in the imaging.

17. The image acquisition method according to claim 16,
wherein in the imaging, the target is illuminated with striped light via the member, and
wherein in the shifting, an amount of relative shift the member and the target in the second direction during the exposure for acquiring the one image is an integral multiple of a half of the period P.

18. The image acquisition method according to claim 16,
wherein in the imaging, the target is illuminated with striped light via the member, and
wherein in the shifting, an amount of relative shift the member and the target in the second direction during the exposure for acquiring the one image is 5 or more times of a half of the period P.

19. The image acquisition method according to claim 16, wherein in the shifting, a distance, by which the relative positions shift within an exposure time needed for capturing the image in the imaging, is an integral multiple of a cycle of a contrast pattern to be generated on the image due to presence of the member.

20. A non-transitory storage medium storing a program for causing a computer to execute image processing, the program causing the computer to perform operations comprising:
illuminating a target;
imaging an area of the illuminated target via a member having a plurality of non-transmissive portions that extends in a first direction and does not transmit at least a part of incident light, the plurality of non-transmissive portions being disposed in a second direction intersecting the first direction at intervals of a period P; and
relatively shifting relative positions of the member and the target in the second direction during exposure for acquiring one image by imaging the area of the target in the imaging.
